(19) United States
(12) Patent Application Publication
(10) Pub. No.: US 2021/0106170 A1
(43) Pub. Date: Apr. 15, 2021

(54) Campfire Grill Stakes

(71) Applicant: Kyle E. Thomas, Syracuse, NY (US)

(72) Inventor: Kyle E. Thomas, Syracuse, NY (US)

(21) Appl. No.: 17/064,732

(22) Filed: Oct. 7, 2020

Related U.S. Application Data
(60) Provisional application No. 62/913,363, filed on Oct. 10, 2019.

(51) Int. Cl. A47J 33/00; F24B 1/00

(52) U.S. Cl. CPC A47J 33/00; F24B 1/003

(57) ABSTRACT

A grill system having a plurality of stakes that may be inserted into the ground around a campfire location. A grill may be supported by the stakes to extend over the campfire location, thereby allowing a user to use the grill for cooking. Each stake has a shaft with a plurality of tabs that extend laterally from the shaft. The tabs are spaced along shaft and may be used to support any conventional grill in a desired height over the campfire regardless of ground conditions or the shape of the grill or firepit.

### CROSS-REFERENCE TO RELATED APPLICATIONS

The present application claims priority to U.S. Provisional App. No. 62/913,363, filed on Oct. 10, 2019.

### BACKGROUND OF THE INVENTION

### 1. Field of the Invention

The present invention relates to campfire grills for primitive or backcountry camping and, more specifically, to a set of stakes for supporting a grill over a camp fire.

### 2. Description of the Related Art

Many designated campgrounds exist that are accessible to motor vehicles or recreational vehicles. At most such facilities, fixed, constructed fire pits equipped with grill grates are established at each campsite for grilling of food. Campsites that are associated with “backcountry” camping, on the other hand are accessible often only by foot or personal non-motorized watercraft such as canoes or kayaks. Cooking at these camp sites is most often performed at a primitive fire pit usually consisting simply of an area of cleared bare ground surrounded by stones obtained from around the camp site. In this scenario, the camper must carry his or her cooking grill along with other camping equipment to the campsite. This involves manual transport over significant distances, which puts a premium on the weight and compactness of equipment, tools and cooking utensils.

Grill assemblies for cooking food over an open fire are well known in the field. A traditional grate for primitive or backcountry camping consists most simply of a small grate that can be set on the stones surrounding the fire pit, or a grate equipped with foldout legs or a stand that can be set inside the fire pit. In both cases establishing a level cooking surface can be a challenge and varying the height of the grate relative to the heat is not practical. Other examples exist in the prior art but these systems have complicated physical structures for supporting a grill at various heights over a fire and are thus often unwieldy and heavy to carry over any distance. In addition, conventional systems are wedded to particular grill size and shape and thus require the user to always have the same grill. As many hikes and paddling excursions can extend over long distances, there is a need in the art for a grill supporting system that allows for variability in grill design and adjustable height that is convenient to manually transport in a backpack, canoe or kayak to remote locations.

### BRIEF SUMMARY OF THE INVENTION

The present invention comprises a campfire grill system for supporting a grill over a campfire at user selective heights and over any ground conditions without the need for extensive and heavy structures. The system includes a plurality of stakes, with each stake extending along a longitudinal axis. Each stake also has a plurality of tabs extending laterally relative to the longitudinal axis. A grill may be supported over a campfire by engaging its peripheral edge with one of the tabs of each stake.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a top plan of a campfire having a grill system according to the present invention;

FIG. 2 is side view of a stake for a grill system according to the present invention; and

FIG. 3A through 3C are a series of alternative stake embodiments according to the present invention.

### DETAILED DESCRIPTION OF THE INVENTION

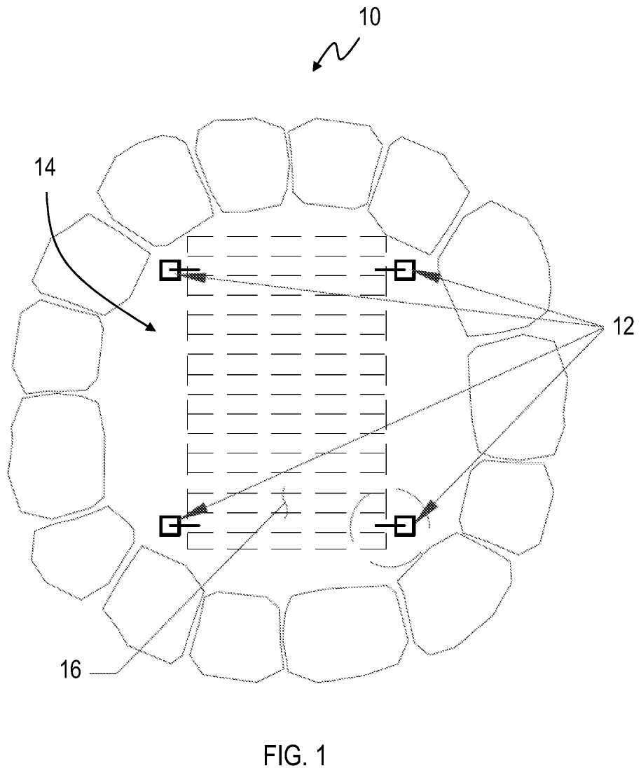

Referring to the figures, wherein like numeral refer to like parts throughout, there is seen in FIG. 1 a grill system 10 according to the present invention. System 10 comprises a plurality of stakes 12 that may be inserted into the ground around a campfire location 14. A grill 16 is coupled to stakes 12 to extend over campfire location 14, thereby allowing a campfire build in campfire location 14 to cook any food placed on grill 16.

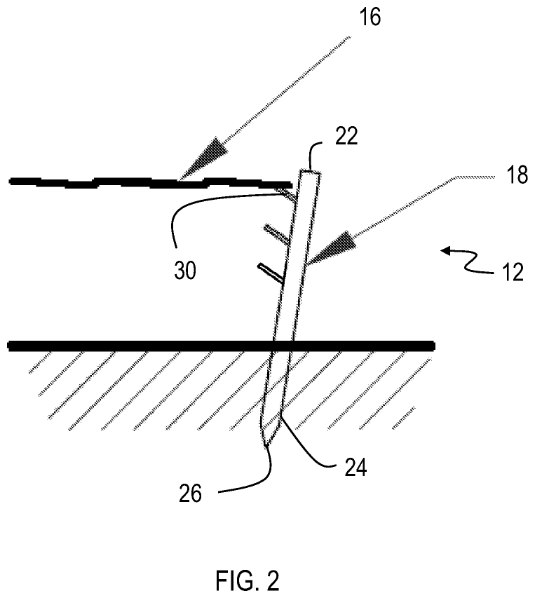

Referring to FIG. 2, each stake 12 comprises a shaft 20 extending from an upper end 22 longitudinally to a lower end 24. Upper end 22 is configured to be driven by a force and thus is preferably flat so that stake 12 can be more easily driven in the ground around campfire location 14. As should be recognized by those of skill in the art, upper end 22 may be flanged and include a head or cap. Lower end 24 is configured to be driven into the ground and thus preferably tapers to a point 26. Stakes 12 are preferably formed from a metal such as steel or aluminum, but could also be made from a heat-resistant plastic.

As further seen in FIG. 2, each stake 12 includes a plurality of tabs 30 that extend laterally from and are positioned regularly along shaft 20. Tabs 30 may be any form of projection, detent, catch, strip or the like that extends outwardly from shaft 20, and may be formed integrally with or attached to shaft 20. Tabs 30 also include the resulting structure formed by removing material from shaft 20 to leave a projection that can support grill 16, such as a slot or opening having a lip that forms tab 30. Tabs 30 are preferably angled so that they project at an angle to point slightly upwards when stake 12 is driven into the ground around campfire location 14. Tabs 30 are spaced along shaft 20 to support grill 16 in various heights over campfire location 14. As each stake includes a plurality of tabs 30, grill 16 can be positioned or repositioned as desired. In addition, the plurality of tabs 30 can be used to account for stakes 12 driven different distances into the ground of campfire location 14, to account for uneven ground in campfire location 14, or to allow grill 16 to be positioned along a slope or to have a slope.

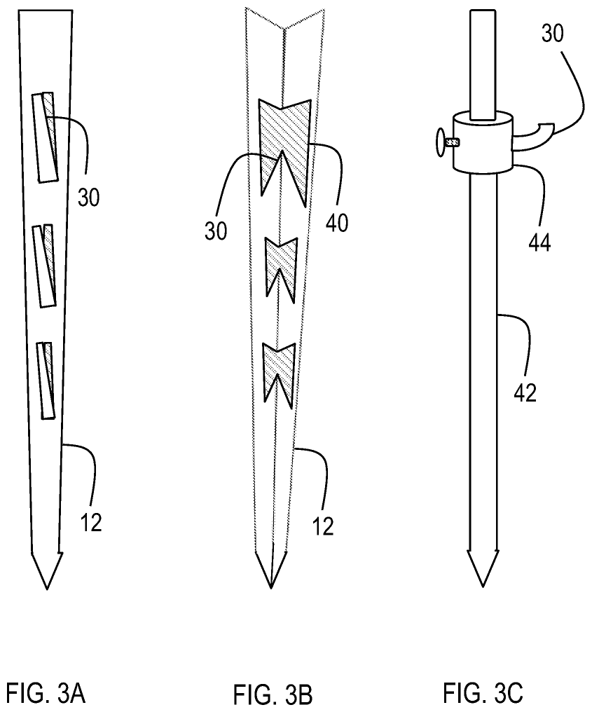

Referring to FIGS. 3A through 3C, tabs 30 of stakes 12 may be provided via a number of different ways. For example, as seen in FIG. 3A, tabs 30 may be formed as punchouts from a flat stake 12. Alternatively, as seen in FIG. 3B, stakes may be formed as a V-shaped member that has a cutout portion 40 that effectively forms tabs 30 from the remaining material of stake 12. Stakes 12 may also be formed from a rod 42 having one or more adjustable collars 44 that carry tabs 30 for supporting grill 16 as seen in FIG. 3C.

A user may thus position stakes 12 about campfire location 14 and support a grill 16 at a desired height and orientation over campfire location 14 by positioning grill 16 so that its peripheral edge engages one tab 30 of each stake 12. While two stakes 12 could support grill 16, it should be recognized that three or four stakes 12 should be used. Stakes 12 will work effectively with any shaped grill 16, i.e., stakes 12 may be used to accommodate conventional square, rectangular, and even circular grills 16 with ease.

What is claimed is:

1. A campfire grill system, comprising a plurality of stakes, wherein each stake extends along a longitudinal axis and has a plurality of tabs extending laterally relative to the longitudinal axis.

2. The campfire grill system of claim 1, further comprising a grill having a peripheral edge that is positioned so that at least one tab of each stake engages the peripheral edge of grill.
